(19) United States
(12) Patent Application Publication
(10) Pub. No.: US 2015/0213831 A1
(43) Pub. Date: Jul. 30, 2015

(54) SPINDLE MOTOR AND HARD DISK DRIVE INCLUDING THE SAME

(71) Applicant: SAMSUNG ELECTRO-MECHANICS CO., LTD., Suwon-Si (KR)

(72) Inventor: Jae Hyuk KIM, Suwon-Si (KR)

(73) Assignee: SAMSUNG ELECTRO-MECHANICS CO., LTD., Suwon-Si (KR)

(21) Appl. No.: 14/590,990

(22) Filed: Jan. 6, 2015

(30) Foreign Application Priority Data
Jan. 29, 2014 (KR) 10-2014-0011273

(51) Int. Cl. G11B 19/20; F16C 41/00

(52) U.S. Cl. CPC G11B 19/2009; F16C 41/004

(57) ABSTRACT

There are provided a spindle motor and a hard disk drive including the same. The spindle motor includes: a lower thrust member fixedly attached to a base member; a shaft having a lower end portion coupled to the lower thrust member and an upper end portion provided with a flange portion; a rotating member including a sleeve rotating based on the shaft; and a fixed member including a fitting protrusion protruding upwardly in an axial direction and fitted into and fixed to a fixation groove recessed upwardly from a lower end of the shaft in the axial direction and a flange caught by a lower surface of the lower thrust member.

### CROSS-REFERENCE TO RELATED APPLICATION

This application claims the benefit of Korean Patent Application No. 10-2014-0011273 filed on Jan. 29, 2014, with the Korean Intellectual Property Office, the disclosure of which is incorporated herein by reference.

### BACKGROUND

The present disclosure relates to a spindle motor and a hard disk drive including the same.

A fixed-shaft type spindle motor in which a shaft having excellent vibration characteristics is fixed to a casing of a hard disk drive is generally mounted in an information recording and reproducing device such as a hard disk drive for a server.

That is, the shaft is fixedly attached in the spindle motor mounted in the hard disk drive for a server in order to prevent information recorded on a disk from being damaged and the hard disk becoming unrecordable or unreadable due to an increase in an amplitude of a rotor caused by external vibrations.

As described above, in the case in which the fixed type shaft is installed, upper and lower thrust members are fixedly attached on the shaft.

However, in the case in which the shaft is fixedly attached to the lower thrust member and the lower thrust member is fixed to a base, since the shaft serving as a rotating shaft should be firmly fixed, the lower thrust member may be relatively thick and is fixed to an outer peripheral surface of the shaft in a scheme such as a press-fitting scheme, a bonding scheme, a slide coupling scheme, or the like. Alternatively, the lower thrust member and the shaft are provided integrally with each other.

Particularly, since the lower thrust member is basically provided in a cup shape in which a disk part and an extension part protrude from the disk part in an axial direction, it may be difficult to process the lower thrust member so that the disk part and the extension part are accurately perpendicular to each other at a boundary portion therebetween. Therefore, a sleeve may come into contact with the boundary portion between the disk part and the extension part, such that a thrust bearing to be formed between the sleeve and the disk part may not play its role.

Further, the lower thrust member may include a fitting protrusion protruding upwardly in the axial direction in a central portion thereof in order to be coupled to the shaft, and in this case, it is also difficult to process the lower thrust member so that the disk part and the fitting protrusion are accurately perpendicular to each other at a boundary portion therebetween. Therefore, the shaft may not be properly fitted to the fitting protrusion, which may be an obstacle to thinning of the motor.

As described above, in a spindle motor according to the related art, thinning of the spindle motor may be inhibited by a structure of a lower thrust member, a length of a bearing span may inevitably be shortened, and the thrust bearing may not properly play its intended role, such that performance of the motor may be inhibited.

### RELATED ART DOCUMENT

### (Patent Document 1) Korean Patent Laid-Open Publication No. 2006-0079630

### SUMMARY

An aspect of the present disclosure may provide a spindle motor allowing for thinning thereof by decreasing a thickness of a lower thrust member coupled to a shaft in an axial direction and allowing coupling strength to be secured while using a fixed-shaft type spindle motor.

An aspect of the present disclosure may also provide a spindle motor capable of improving operational performance thereof by decreasing a thickness of a lower thrust member coupled to a shaft in an axial direction to decrease the overall thickness of the motor and form a bearing span to be elongated while using a fixed-shaft type spindle motor.

According to an aspect of the present disclosure, a spindle motor may include: a lower thrust member fixedly attached to a base member; a shaft having a lower end portion coupled to the lower thrust member and an upper end portion provided with a flange portion; a rotating member including a sleeve rotating based on the shaft; and a fixed member including a fitting protrusion protruding upwardly in an axial direction and fitted into and fixed to a fixation groove recessed upwardly from a lower end of the shaft in the axial direction and a flange caught by a lower surface of the lower thrust member.

The fitting protrusion may be slidably inserted into the fixation groove.

An adhesive may be applied between an outer surface of the fitting protrusion and the fixation groove, such that the fitting protrusion and the fixation groove may be bonded to each other.

The fitting protrusion may be at least partially press-fitted into the fixation groove.

The fitting protrusion may be screw-coupled to the fixation groove.

A seating groove on which the flange is seated may be provided in the lower surface of the lower thrust member.

A coupling length between the lower thrust member and the shaft in the axial direction may be 10 to 15% of a length of a bearing span formed between the shaft and the sleeve.

A through hole may be provided in the lower thrust member, such that a lower end portion of the shaft may be fitted into the through hole.

The shaft may be slidably inserted into the through hole.

The shaft may be press-fitted into the through hole.

According to another aspect of the present disclosure, a hard disk drive may include: the spindle motor as described above, rotating a disk by power applied thereto through a substrate; a magnetic head writing data to and reading data from the disk; and a head transfer part transferring the magnetic head to a predetermined position on the disk.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view illustrating a spindle motor according to an exemplary embodiment of the present disclosure;

FIG. 2 is an enlarged view illustrating an example of part A of FIG. 1;

FIG. 3 is an enlarged view illustrating another example of part A of FIG. 1;

FIG. 4 is an enlarged view illustrating another example of part A of FIG. 1; and

FIG. 5 is a schematic cross-sectional view illustrating a recording disk driving device including the spindle motor according to an exemplary embodiment of the present disclosure mounted therein.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

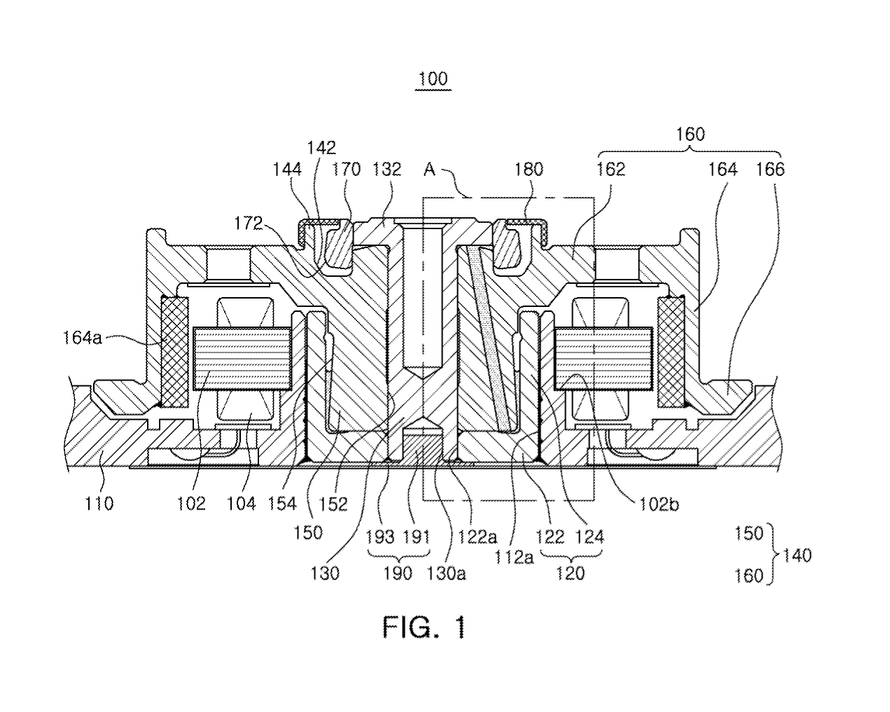

FIG. 1 is a schematic cross-sectional view illustrating a spindle motor according to an exemplary embodiment of the present disclosure.

Referring to FIG. 1, a spindle motor 100 according to an exemplary embodiment of the present disclosure may include, for example, a base member 110, a lower thrust member 120, a shaft 130, a rotating member 140, a sealing member 170, a cap member 180, and a fixed member 190.

Meanwhile, the spindle motor 100 according to an exemplary embodiment of the present disclosure may be a motor used in a recording disk driving device rotating a recording disk.

The base member 110 may include an installation part 112 having a stator core 102 installed therein. An installation hole 112a into which the lower thrust member 120 as described above is inserted may be formed in the installation part 112 and extended upwardly in an axial direction.

Here, terms with respect to directions will be defined. As viewed in FIG. 1, the axial direction refers to a vertical direction, that is, a direction from a lower end portion of the shaft 130 toward an upper end portion thereof or a direction from the upper end portion of the shaft 130 toward the lower end portion thereof, and a radial direction refers to a horizontal direction, that is, a direction from the shaft 130 toward an outer peripheral surface of the rotating member 140 or a direction from the outer peripheral surface of the rotating member 140 toward shaft 130.

In addition, a circumferential direction refers to a rotation direction along an outer peripheral surface of the shaft 130.

Meanwhile, a supporting surface 112b supporting the stator core 102 may be formed at an outer peripheral surface of the installation part 112. As an example, the stator core 102 may be fixedly attached at the installation part 112 in a state in which it is seated on a supporting surface 112b of the installation part 112.

Although the case in which an inner peripheral portion of the stator core 102 is seated on and installed at the installation part 112 of the base member 120 is described by way of example in the present exemplary embodiment, the present disclosure is not limited thereto. For example, the stator core 102 may be installed at a separate installation member or a lower thrust member having a shape changed in order to install the stator core 102. In this case, the base member 120 may not include the installation part 112.

The lower thrust member 120 may be inserted into the installation hole 112a of the installation part 112, and an outer peripheral surface of the lower thrust member 120 may be bonded to an inner peripheral surface of the installation part 112.

In this case, the lower thrust member 120 may be fixedly attached to the installation part 122 in any one of an adhesion scheme, a press-fitting scheme, and a welding scheme.

Meanwhile, the lower thrust member 120 may have a disk shape and include a disk part 122 having a through hole 122a formed therein so that a lower end portion of the shaft 130 is inserted thereinto and a sealing wall part 124 extended upwardly from an edge of the disk part 122 in the axial direction.

In addition, the lower thrust member 120 may form a sealing part in which an interface between a lubricating fluid and air (that is, a liquid-vapor interface) is formed together with the rotating member 140.

The lower end portion of the shaft 130 may be coupled to the lower thrust member 120, and an upper end portion thereof may be provided with a flange portion 132. As an example, the lower end portion of the shaft 130 may be inserted into the through hole 122a of the lower thrust member 120 to thereby be coupled to the lower thrust member 120. In this case, the shaft 130 may be coupled to the through hole 122a by a sliding method and an adhesive bonding method or at least partially press-fitted into the through hole 122a. Of course, in the case of press-fitting, an adhesive may be additionally interposed.

That is, the spindle motor 100 according to an exemplary embodiment of the present disclosure may have a fixed-shaft structure in which the shaft 130 is fixedly attached.

Meanwhile, the shaft 130 may form a bearing clearance in which the lubricating fluid is filled, together with the rotating member 140.

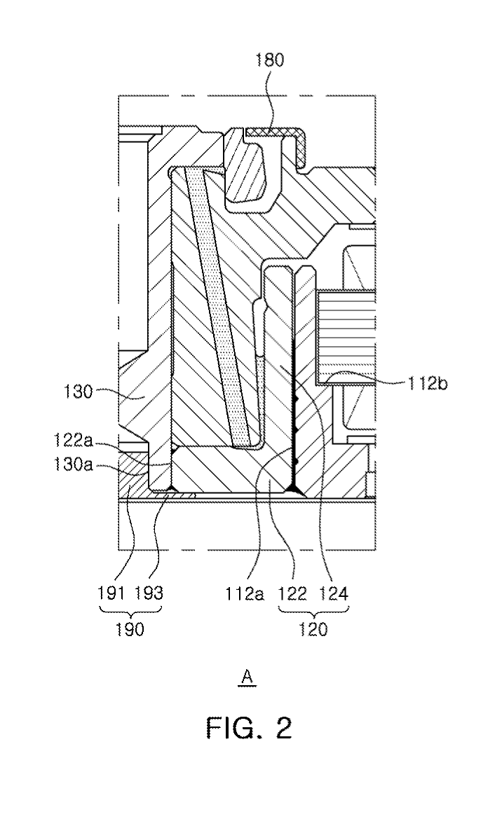

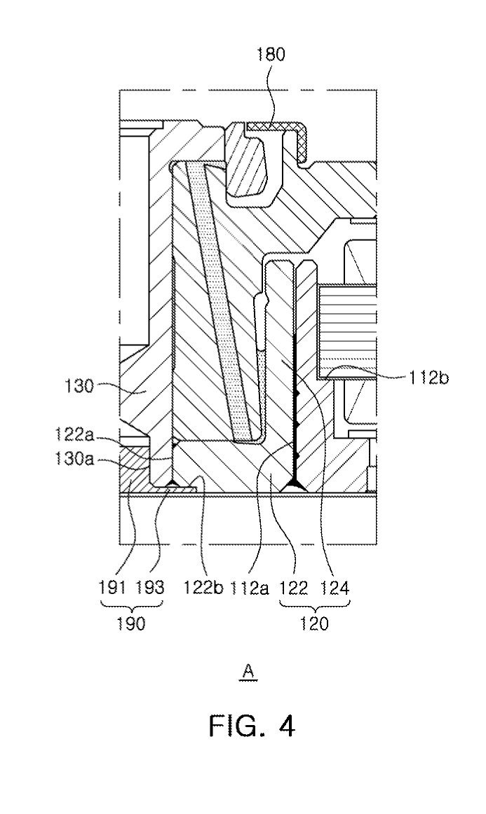

In addition, according to an exemplary embodiment of the present disclosure, the fixed member 190 coupling the shaft 130 and the lower thrust member 120 to each other may be further included in order to further facilitate fixation of the shaft 130. A detailed description thereof will be provided with reference to FIGS. 2 through 4.

The rotating member 140 may rotate based on the shaft 130. In addition, an installation groove 142 in which the flange portion 132 of the shaft 130 as described above is insertedly disposed may be formed in the rotating member 140. The flange portion 132 and the sealing member 170 as described above may be insertedly disposed in the installation groove 142. Further, an installation protrusion 144 for installing the cap member 180 may be provided at the rotating member 140.

Meanwhile, the rotating member 140 may include a sleeve 150 forming the bearing clearance together with the lower thrust member 120 and the shaft 130 and a rotor hub 160 extended from the sleeve 150.

The sleeve 150 may be disposed between the flange portion 132 of the shaft 130 and the disk part 122 of the lower thrust member 130 and form the bearing clearance together with the shaft 130 and the lower thrust member 120.

Meanwhile, the sleeve 150 may include a shaft hole 152 formed therein, wherein the shaft hole 152 has the shaft 130 penetrating therethrough. That is, the rotating member 140 may rotate based on the shaft 130 insertedly disposed in the shaft hole 152 of the sleeve 150.

In addition, upper and lower radial dynamic pressure grooves (not shown) may be provided in at least one of an inner peripheral surface of the sleeve 150 and the outer peripheral surface of the shaft 130. The upper and lower radial dynamic pressure grooves may be disposed to be spaced apart from each other in the axial direction by a predetermined interval, and generate fluid dynamic pressure in the radial direction at the time of rotation of the sleeve 150.

Therefore, the rotating member 140 may more stably rotate.

Meanwhile, an inclined surface 154 for forming the liquid-vapor interface together with the sealing wall part 124 of the lower thrust member 120 may be formed at a lower end portion of an outer peripheral surface of the sleeve 150. Therefore, the interface between the lubricating fluid and the air may be formed in a space formed by the inclined surface 154 and an inner peripheral surface of the sealing wall part 124 due to a capillary phenomenon.

The rotor hub 160 may be extended from the sleeve 150. Meanwhile, although the case in which the rotor hub 160 and the sleeve 150 are formed integrally with each other is described in the present exemplary embodiment by way of example, the present disclosure is not limited thereto. The rotor hub 160 and the sleeve 150 may be separately manufactured and assembled with each other.

Meanwhile, the rotor hub 160 may include a body 162 having a disk shape, a magnet mounting part 164 extended downwardly from an edge of the body 162 in the axial direction, and a disk supporting part 166 extended from a distal end of the magnet mounting part 164 in the radial direction.

In addition, the magnet mounting part 164 may include a driving magnet 164a fixedly attached to an inner surface thereof. Therefore, an inner surface of the driving magnet 164a may be disposed to face a front end of the stator core 102.

Meanwhile, the driving magnet 164a may be a permanent magnet generating magnetic force having a predetermined strength by alternately magnetizing an N pole and an S pole thereof in the circumferential direction.

Here, a rotational driving scheme of the rotating member 140 will be simply described. When power is applied to a coil 104 wound around the stator core 102, driving force rotating the rotating member 140 may be generated by electromagnetic interaction between the stator core 102 including the coil 104 wound therearound and the driving magnet 164a, thereby rotating the rotating member 140.

That is, the rotating member 140 may be rotated by the electromagnetic interaction between the driving magnet 164a and the stator core 102 including the coil 104 wound therearound and disposed to face the driving magnet 164a.

The sealing member 170 may be fixedly attached to the flange portion 132 of the shaft 130. That is, an inner peripheral surface of the sealing member 170 may be bonded to an outer peripheral surface of the flange portion 132. Meanwhile, an inclined surface 172 for forming a liquid-vapor interface may be formed at the sealing member 170. As an example, the liquid-vapor interface may be formed in a space formed by an outer peripheral surface of the sealing member 170 and a side wall part forming an installation groove 142 of the rotating member 140. To this end, the inclined surface 172 may be formed at the outer peripheral surface of the sealing member 170.

Meanwhile, the sealing member 170 may have a circular ring shape.

The cap member 180 may be fixedly attached to the rotating member 140 and serve to prevent leakage of the lubricating fluid. Meanwhile, the cap member 180 may have a bent shape. As an example, the cap member 180 may be installed by the bonding between a portion thereof extended in the axial direction and the installation protrusion 144 formed at the rotating member 140. In addition, the cap member 180 may be fixedly attached to the rotating member 140 by any one of an adhesion scheme and a welding scheme.

FIGS. 2 through 4 are enlarged views illustrating various examples of part A of FIG. 1.

Referring to FIGS. 2 through 4, the spindle motor 100 according to an exemplary embodiment of the present disclosure may include a fixed member 190 increasing coupling force of the shaft 130 and the lower thrust member 120.

The fixed member 190 may include a fitting protrusion 191 protruding upwardly in the axial direction and fitted into and fixed to a fixation groove 130a recessed upwardly from a lower end of the shaft 130 in the axial direction and a flange 193 caught by a lower surface of the lower thrust member 120.

Therefore, since additional coupling force corresponding to coupling force between the fitting protrusion 191 and the shaft 130 is added, coupling force between the shaft 130 and the lower thrust member 120 may be increased.

Here, the fitting protrusion 191 may be slidably inserted into the fixation groove 130a. Further, an adhesive may be additionally applied between an outer surface of the fitting protrusion 191 and the fixation groove 130a, such that the fitting protrusion 191 and the fixation groove 130a may be bonded to each other (see FIG. 2).

Alternatively, the fitting protrusion 191 may be at least partially press-fitted into the fixation groove 130a, and an adhesive may be additionally applied between the outer surface of the fitting protrusion 191 and the fixation groove 130a, such that the fitting protrusion 191 and the fixation groove 130a may be bonded to each other (see FIG. 2).

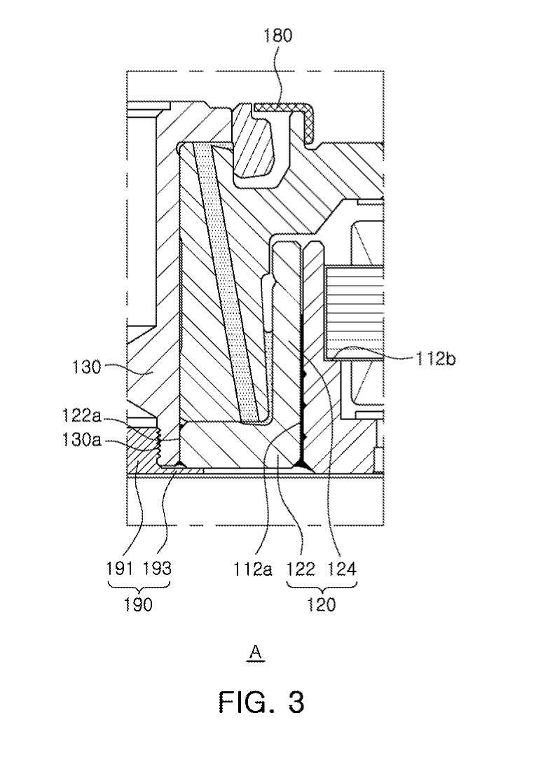

Further, the fitting protrusion 191 may be screw-coupled to the fixation groove 130a (see FIG. 3).

Here, a seating groove 122b on which the flange 193 is seated may be formed at the lower surface of the lower thrust member 120. Therefore, the lower surface of the lower thrust member 120 and a lower surface of the flange 193 may be continuously provided.

In addition, a coupling length between the lower thrust member 120 and the shaft 120 in the axial direction may be 10 to 15% of a length of a bearing span formed between the shaft 130 and the sleeve 150. Here, the length of the bearing span may mean a length in the axial direction of surfaces of the sleeve 150 and the shaft 130 facing each other in the radial direction.

In the case of a fixed-shaft type spindle motor according to the related art, since the shaft 130 is fixed only to the lower thrust member 120, in order to secure fixing force, a coupling length between the shaft 130 and the lower thrust member 120 in the axial direction is generally about 30% of the length of the bearing span. Therefore, in a situation in which a thickness spec of a hard disk drive is determined, there is a problem in that the length of the bearing span may be decreased, and accordingly, bearing rigidity may be weakened. The present disclosure may solve this problem.

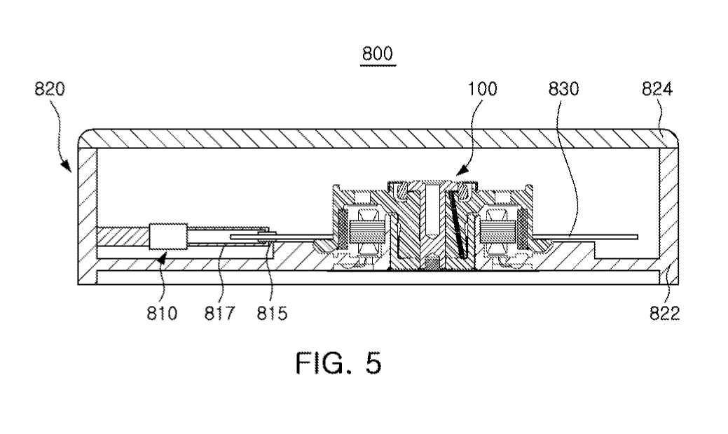

FIG. 5 is a schematic cross-sectional view illustrating a recording disk driving device having the spindle motor according to an exemplary embodiment of the present disclosure mounted therein.

Referring to FIG. 5, a recording disk driving device 800 including the spindle motor 100 according to an exemplary embodiment of the present disclosure mounted therein may be a hard disk drive and include the spindle motor 100, a head transfer part 810, and a housing 820.

The spindle motor 100 has all the characteristics of the motor according to the present disclosure described above and may have a recording disk 830 mounted thereon.

The head transfer part 810 may transfer a magnetic head 815 detecting information of the recording disk 830 mounted in the spindle motor 100 to a surface of the recording disk of which the information is to be detected.

Here, the magnetic head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100 and the head transfer part 810.

As set forth above, according to exemplary embodiments of the present disclosure, while the fixed-shaft type spindle motor is used, the thickness of the lower thrust member coupled to the shaft in an axial direction may be decreased and coupling strength may be secured, such that the spindle motor capable of implementing thinness of the motor may be provided.

In addition, while the fixed-shaft type spindle motor is used, the lower thrust member may be coupled to the shaft in the state in which a thickness of the lower thrust member in the axial direction is decreased, such that the overall thickness of the motor may be thinned, and the bearing span length may be formed to be long, thereby improving operational performance of the spindle motor.

While exemplary embodiments have been shown and described above, it will be apparent to those skilled in the art that modifications and variations could be made without departing from the scope of the present invention as defined by the appended claims.

What is claimed is:

1. A spindle motor comprising:
a lower thrust member fixedly attached to a base member;
a shaft having a lower end portion coupled to the lower thrust member and an upper end portion provided with a flange portion;
a rotating member including a sleeve rotating based on the shaft; and
a fixed member including a fitting protrusion protruding upwardly in an axial direction and fitted into and fixed to a fixation groove recessed upwardly from a lower end of the shaft in the axial direction and a flange caught by a lower surface of the lower thrust member.

2. The spindle motor of claim 1, wherein the fitting protrusion is slidably inserted into the fixation groove.

3. The spindle motor of claim 2, wherein an adhesive is applied between an outer surface of the fitting protrusion and the fixation groove, such that the fitting protrusion and the fixation groove are bonded to each other.

4. The spindle motor of claim 1, wherein the fitting protrusion is at least partially press-fitted into the fixation groove.

5. The spindle motor of claim 1, wherein the fitting protrusion is screw-coupled to the fixation groove.

6. The spindle motor of claim 1, wherein a seating groove on which the flange is seated is provided in the lower surface of the lower thrust member.

7. The spindle motor of claim 1, wherein a coupling length between the lower thrust member and the shaft in the axial direction is 10 to 15% of a length of a bearing span formed between the shaft and the sleeve.

8. The spindle motor of claim 1, wherein a through hole is provided in the lower thrust member, such that the lower end portion of the shaft is fitted into the through hole.

9. The spindle motor of claim 8, wherein the shaft is slidably inserted into the through hole.

10. The spindle motor of claim 8, wherein the shaft is press-fitted into the through hole.

11. The spindle motor of claim 9, wherein an adhesive is interposed between the shaft and the lower thrust member.

12. The spindle motor of claim 10, wherein an adhesive is interposed between the shaft and the lower thrust member.

13. A hard disk drive comprising:
the spindle motor of claim 1, rotating a disk by power applied thereto through a substrate;
a magnetic head writing data to and reading data from the disk; and
a head transfer part transferring the magnetic head to a predetermined position on the disk.
